(19) United States
(12) Patent Application Publication
(10) Pub. No.: US 2011/0019088 A1
(43) Pub. Date: Jan. 27, 2011

(54) DIGITAL TELEVISION SIGNAL PROCESSOR AND METHOD OF DISPLAYING SUBTITLE

(76) Inventor: Daisuke Kase, Osaka (JP)

Correspondence Address: WENDEROTH, LIND & PONACK L.L.P., 1030 15th Street, N.W., Suite 400 East, Washington, DC, 20005-1503, US

(21) Appl. No.: 12/922,762

(22) PCT Filed: Mar. 6, 2009
(86) PCT No.: PCT/JP2009/001021

§ 371 Date: Sep. 15, 2010

(30) Foreign Application Priority Data
Apr. 17, 2008 (JP) 2008-107652

(51) Int. Cl. H04N 7/035

(52) U.S. Cl. 348/468; 348/E07.02

(57) ABSTRACT

A digital television signal processor stores moving image resolution of a display unit in advance, and reduces an afterimage of subtitle on the display unit by controlling a subtitle scrolling speed based on the stored moving image resolution.

### TECHNICAL FIELD

The present invention relates to digital television signal processors, and more particularly to control of subtitle displaying speed.

### BACKGROUND ART

Digital television broadcasting is now rapidly spreading throughout the world. In addition, display devices have been changed from conventional CRTs (Cathode Ray Tubes) to thin display devices such as a PDP (Plasma Display Panel) and LCD (Liquid Crystal Display). In these new display devices, display devices with low resolution for moving images, such as LCDs, generate afterimages when fast moving images are displayed. In particular, LCDs generate conspicuous afterimages when displaying subtitles at a fast scrolling speed.

To solve this problem, a method of reducing afterimages at displaying subtitles is conventionally proposed with respect to display devices. For example, Patent Literature 1 discloses a prior art of improving readability by displaying subtitles at a slower scrolling speed for aged people. This prior art is described below with reference to a drawing.

FIG. 15 illustrates a conventional digital television signal processor. The conventional digital television signal processor is configured as follows.

Image encoder 1301 receives an image signal, and encodes the input image signal to a MPEG signal. First audio encoder 1302 receives a normal first audio signal, and encodes the input audio signal to a MPEG signal. Second audio encoder 1303 receives a second audio signal, which is the first audio signal input to first audio encoder 1302 with converted speed. Second audio encoder 1303 encodes the input speed-converted audio signal to a MPEG signal. First subtitle encoder 1304 generates subtitle data synchronized with audio output of first audio encoder 1302. Second subtitle encoder 1305 generates subtitle data synchronized with audio output of second audio encoder 1303.

Multiplexer 1306 multiplexes outputs from aforementioned encoders. Then, multiplexer 1306 outputs a signal, in which the outputs are multiplexed, as a transport stream. Modulator 1307 modulates in accordance with a modulation system specified as a broadcast system, such as OFDM (Orthogonal Frequency Division Multiplexing). Radio wave transmitter 1308 converts the frequency of output from modulator 1307, and outputs an amplified signal to a transmission antenna. Output terminal 1309 is an output terminal of radio wave transmitter 1308 toward the transmission antenna.

With the above configuration, first subtitle encoder 1304 can generate subtitle data corresponding to the normal first audio signal. In addition, second subtitle encoder 1305 can generate subtitle data corresponding to the second audio signal with converted audio speed.

The scrolling speed of subtitles output from second subtitle encoder 1305 can be set slower than the scrolling speed of subtitles output from first subtitle encoder 1304. More specifically, in the prior art described above, multiple subtitles are superimposed on broadcast wave in advance, and these subtitles include a subtitle with slow displaying speed (Patent Literature 1).

Furthermore, a technology of recognizing characters in displayed tickers, and converting their displaying speed is disclosed (Patent Literature 2).

Prior arts disclosed in Patent Literature 1 and Patent Literature 2 can display subtitles at multiple scrolling speeds. However, they are not capable of providing an optimum scrolling speed depending on moving image resolution of each display device.

Patent Literature 1: Japanese Patent Unexamined Publication No. 2005-57638

Patent Literature 2: Japanese Patent Unexamined Publication No. 2000-69390

### SUMMARY OF THE INVENTION

A digital television signal processor of the present invention receives an input image signal and a digital signal including subtitle data, and displays them on a display unit. The digital television signal processor includes a moving image resolution memory, a lookup table converter, a subtitle data memory, a subtitle scroll converter, a subtitle OSD (On Screen Display) generator, and a subtitle OSD synthesizer.

The moving image resolution memory stores moving image resolution of the display unit. The lookup table converter outputs a scrolling speed conversion identifier for subtitles corresponding to the moving image resolution of the display unit. The subtitle data memory stores subtitle data. Subtitle scroll converter converts a scrolling speed identifier, which determines the subtitle scrolling speed included in the subtitle data stored in the subtitle data memory, based on the scrolling speed conversion identifier output from the lookup table converter. Subtitle OSD generator outputs a subtitle OSD image signal from the subtitle data based on the converted scrolling speed identifier output from the subtitle scroll converter. The subtitle OSD synthesizer receives and synthesizes the input image signal and the subtitle OSD image signal. The subtitle scroll converter controls the subtitle scrolling speed depending on the moving image resolution of the display unit.

Still more, in the digital television signal processor of the present invention, the subtitle scroll converter may control the subtitle scrolling speed to a predetermined level or below depending on the moving image resolution of the display unit.

Furthermore, in the digital television signal processor of the present invention, the subtitle scroll converter may convert a value of the scrolling speed identifier stored in the subtitle data memory to a value of the scrolling speed conversion identifier output from the lookup table converter if the value of scrolling speed identifier of the subtitle data stored in the subtitle data memory exceeds the value of scrolling speed conversion identifier output from the lookup table converter.

With this configuration, the subtitle scrolling speed can be limited to the predetermined level or below depending on the moving image resolution of each display unit of the digital television processor. As a result, afterimages are eliminated, or suppressed to a predetermined level or below.

Still more, in the digital television signal processor of the present invention, subtitle OSD synthesizer may further include a subtitle overlap detector for detecting any overlap between the subtitle and another content in the input image signal. The subtitle OSD generator further includes an inter-character space converter for converting an inter-character space of the subtitle. If the subtitle overlap detector detects any overlap between the subtitle and another content included in the input image signal, the inter-character space converter may narrow the inter-character space of subtitle.

Still more, in the digital television signal processor of the present invention, the subtitle OSD synthesizer may further include a subtitle overlap detector for detecting any overlap between the subtitle and another content included in the input image signal. The subtitle OSD generator further includes the subtitle line converter for converting the number of subtitle lines. If the subtitle overlap detector detects any overlap between the subtitle and another content included in the input image signal, the subtitle line converter may convert to a subtitle in two or more lines.

Still more, in the digital television signal processor of the present invention, the subtitle OSD synthesizer may further include a subtitle overlap detector for detecting any overlap between the subtitle and another content included in the input image signal. The subtitle OSD generator further includes a subtitle font changer for changing a font size of subtitle. If the subtitle overlap detector detects any overlap between the subtitle and another content included in the input image signal, the subtitle font changer may change to a subtitle with a smaller font size.

Furthermore, in the digital television signal processor of the present invention, the subtitle scroll converter further includes a change permission flag determination unit for determining whether or not to change the subtitle scrolling speed with reference to a change permission flag for scrolling speed included in the subtitle data. If the change permission flag for scrolling speed permits change at determination of change by the change permission flag determination unit, the subtitle scroll converter converts the scrolling speed identifier. If the change permission flag for scrolling speed does not permit change, conversion of the scrolling speed identifier may be stopped.

A method of displaying subtitle of the present invention stores moving image resolution of a display unit, and outputs a subtitle scrolling speed conversion identifier corresponding to the moving image resolution in a digital television signal process that receives an input image signal and a digital signal including subtitle data and displays them on the display unit. Subtitle data is stored, and the scrolling speed identifier that determines the subtitle scrolling speed, which is included in the stored subtitle data, is converted based on a scrolling speed conversion identifier. A subtitle OSD image signal is output from the subtitle data based on the converted scrolling speed identifier. Then, a display image signal is synthesized by inputting the input image signal and the subtitle OSD image signal, and a subtitle is displayed by controlling the subtitle scrolling speed depending on the moving image resolution of the display unit.

### BRIEF DESCRIPTION OF DRAWINGS

FIG. 1 is a diagram of a digital television signal processor in accordance with a first exemplary embodiment of the present invention.

FIG. 2 is an example of data formation of an identifier that specifics a subtitle scrolling speed.

FIG. 3 is an input and output characteristics chart of a lookup table converter in the digital television signal processor in accordance with the first exemplary embodiment of the present invention.

FIG. 4 is a flow chart illustrating an example of an operation of a subtitle scroll converter in the digital television signal processor in accordance with the first exemplary embodiment of the present invention.

FIG. 5 is a chart illustrating the relationship between a scrolling speed identifier for display, corresponding to a predetermined scrolling speed conversion identifier, and a scrolling speed identifier detected in input subtitle data.

FIG. 6 is a diagram of a digital television signal processor in accordance with a second exemplary embodiment of the present invention.

FIG. 7 is an example of a data formation of an extended control signal including an inter-character space parameter of subtitle.

FIG. 8 is a flow chart illustrating an example of an operation of the digital television signal processor in accordance with the second exemplary embodiment of the present invention.

FIG. 9 is a diagram of another example of the digital television signal processor in accordance with the second exemplary embodiment of the present invention.

FIG. 10 is a flow chart illustrating an example of an operation of another example of the digital television signal processor in accordance with the second exemplary embodiment of the present invention.

FIG. 11 is a diagram of still another example of the digital television signal processor in accordance with the second exemplary embodiment of the present invention.

FIG. 12 is a flow chart illustrating an example of an operation of still another example of the digital television signal processor in accordance with the second exemplary embodiment of the present invention.

FIG. 13 is a diagram of a digital television signal processor in accordance with a third exemplary embodiment of the present invention.

FIG. 14 is a flow chart illustrating an example of an operation of a subtitle scroll converter in the digital television signal processor in accordance with the third exemplary embodiment of the present invention.

FIG. 15 is a diagram of a conventional subtitle data transmitter.

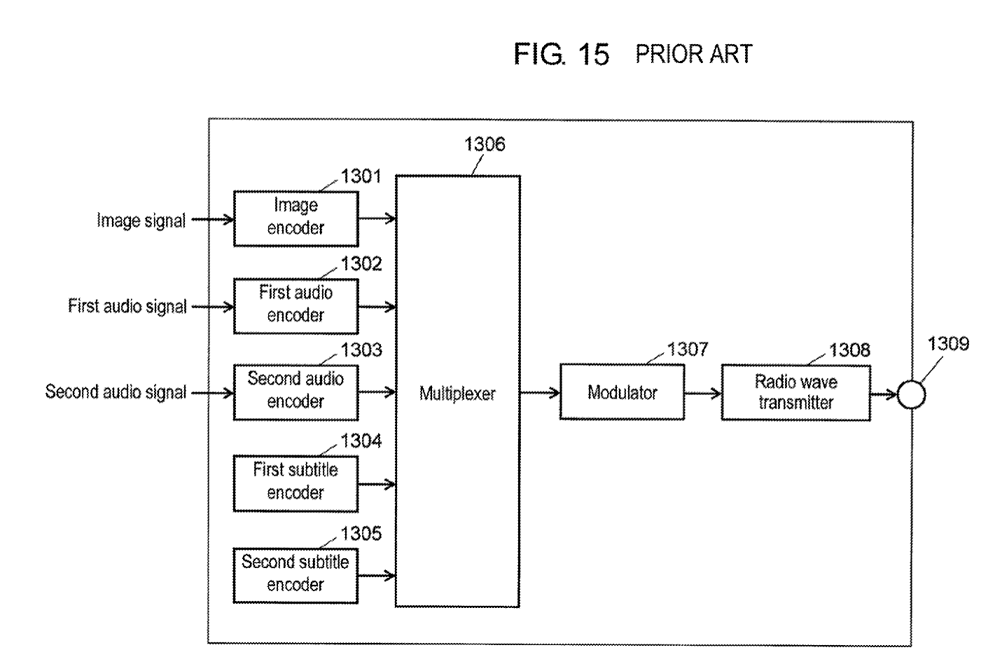

### REFERENCE MARKS IN THE DRAWINGS

21, 23, 25, 27, 29 Digital television signal processor
103 Subtitle OSD synthesizer
104 Display unit
105 Subtitle data memory
106 Subtitle scroll converter
107 Subtitle OSD generator
108 Moving image resolution memory
109 Lookup table converter
110 Remote control
122 Input image signal
124, 125, 126 Subtitle data
128 Subtitle OSD image signal
130 Display image signal
132 Subtitle overlap detection signal
501 White circle
502 Arrow
503 Black circle
701 Inter-character space converter
703 Subtitle overlap detector
705 Subtitle line converter
707 Subtitle font changer
901 Change permission flag determination unit

### DETAILED DESCRIPTION OF PREFERRED EMBODIMENTS

Exemplary embodiments of the present invention are described below with reference to drawings.

### First Exemplary Embodiment

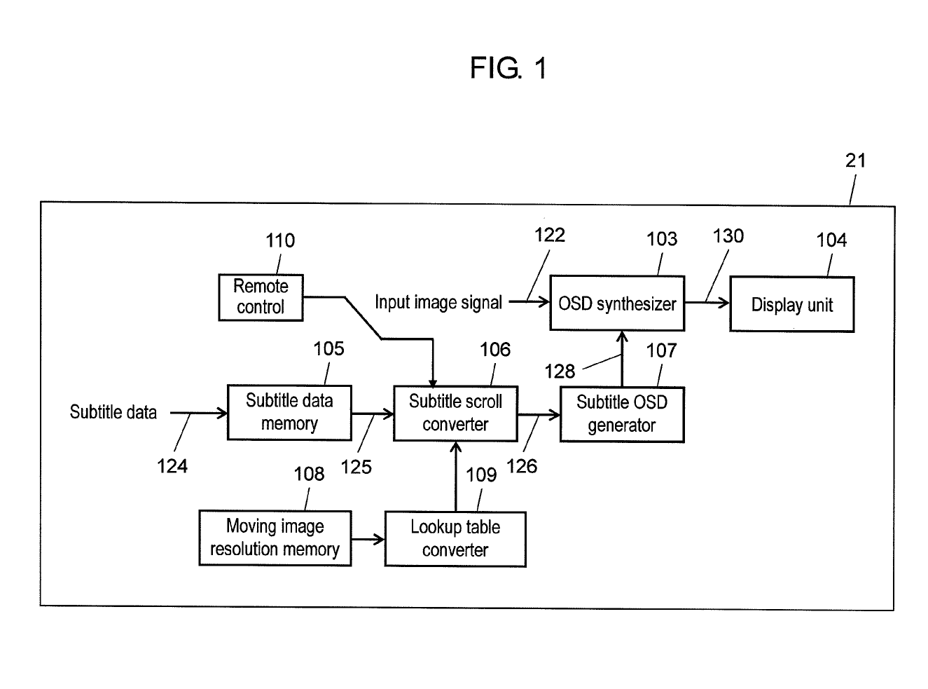

An exemplary embodiment of a digital television signal processor of the present invention is described below. FIG. 1 is a diagram of digital television signal processor 21 in this exemplary embodiment. As shown in FIG. 1, digital television signal processor 21 includes subtitle OSD synthesizer 103, display unit 104, subtitle data memory 105, subtitle scroll converter 106, subtitle OSD generator 107, moving image resolution memory 108, lookup table converter 109, and remote control 110. Digital television signal processor 21 receives input image signal 122 and a digital signal including subtitle data 124, and displays them on display unit 104. Configuration of this digital television signal processor 21 is detailed below.

Subtitle OSD synthesizer 103 receives input image signal 122. This input image signal 122 is, for example, MPEG transport stream (hereafter abbreviated as “MPEG-TS”), or MPEG program stream (hereafter abbreviated as “MPEG-PS”). AV decoder (not illustrated) executes AV decoding of input image signal 122. Subtitle OSD synthesizer 103 receives and synthesizes AV-decoded input image signal 122 and subtitle OSD image signal 128 outputs from subtitle OSD generator 107. Display unit 104 displays synthesized display image signal 130.

Subtitle data memory 105 receives subtitle data 124. Demultiplexer (not illustrated) extracts this subtitle data 124 from, for example, MPEG-TS or MPEG-PS. Subtitle data memory 105 stores input subtitle data 124. And, subtitle data memory 105 outputs this stored subtitle data 125 to subtitle scroll converter 106.

Moving image resolution memory 108 stores moving image resolution of display unit 104. Then, this moving image resolution is output to lookup table converter 109. Lookup table converter 109 outputs a subtitle scrolling speed conversion identifier corresponding to the moving image resolution stored in moving image resolution memory 108.

A scrolling speed identifier that determines the subtitle scrolling speed is included in subtitle data 125 stored in subtitle data memory 105. Subtitle scroll converter 106 converts this scrolling speed identifier based on a scrolling speed conversion identifier output from lookup table converter 109. Subtitle scroll converter 106 outputs subtitle data 126 including converted scrolling speed identifier to subtitle OSD generator 107. The operation of subtitle scroll converter 106 is detailed later.

Subtitle OSD generator 107 generates subtitle OSD image signal 128 from subtitle data 126 based on the converted scrolling speed identifier output from subtitle scroll converter 106. This subtitle OSD image signal 128 is output to subtitle OSD synthesizer 103.

Next, the operation of digital television signal processor 21 as configured above is detailed.

First, input image signal 122 input to subtitle OSD synthesizer 103 is included, for example, in PES (Packetized Elementary Stream) in MPEG-TS or MPEG-PS. Subtitle OSD synthesizer 103 synthesizes input image signal 122 and subtitle OSD image signal 128 output from subtitle OSD generator 107. Display unit 104 displays this synthesized display image signal 130.

Next, the operation of subtitle processing is described. First, a method of detecting a scrolling speed of subtitle data 124 is described. Subtitle data 124 input to subtitle data memory 105 is included, for example, in PES in MPEG-TS or MPEG-PS. The scrolling speed of this subtitle data 124 is determined by the scrolling speed identifier in subtitle data 124.

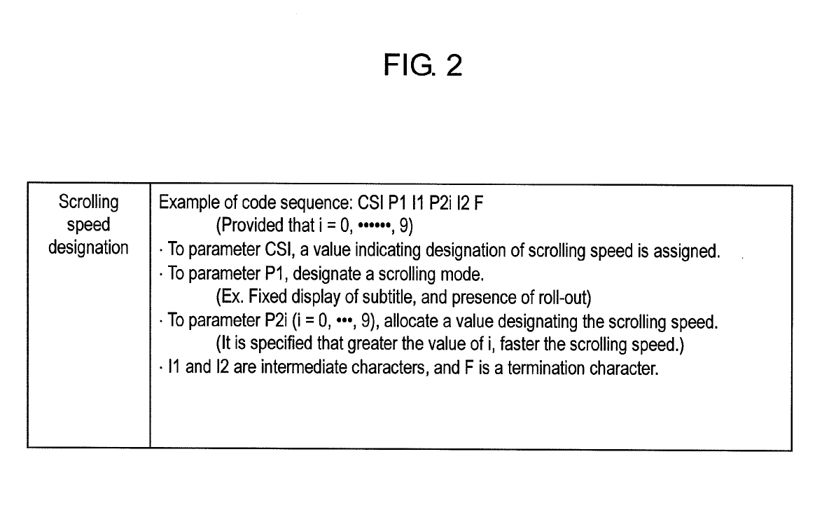

FIG. 2 is an example of data formation of an identifier specifying the subtitle scrolling speed. FIG. 2 shows an example of the scrolling speed identifier in subtitle data 124. More specifically, a code sequence is, for example, designated as “CSI P1 I1 P2i (i=0, . . . , 9), I2 F.” Here, a value indicating that this code is for designating the scrolling speed of subtitle data 124 is assigned to parameter CSI. Parameter P1 designates a scroll mode of characters in subtitle data 124. For example, fixed display without scrolling or display without roll-out is designated in the scroll mode. Parameter P2i (i=0, . . . , 9) designates the scrolling speed of characters in subtitle data 124. Here, this parameter specifies that the character scrolling speed becomes faster as the value of i becomes greater. Parameter I1 and parameter I2 are intermediate characters in the code sequence, and parameter F is a termination character that delimits the code sequence.

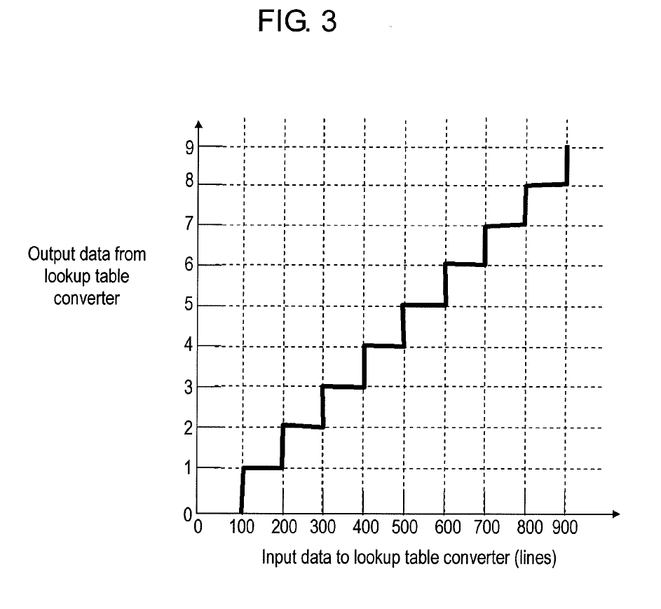

Next, the operation of lookup table converter 109 is described. FIG. 3 is an input and output characteristics chart of lookup table converter 109 in digital television signal processor 21 in the first exemplary embodiment of the present invention. As already described, the scrolling speed faster than a predetermined value causes afterimages in display unit 104 with low moving image resolution. Therefore, it is important to set the scrolling speed depending on moving image resolution.

The horizontal axis in FIG. 3 is the moving image resolution of display unit 104, which is stored in moving image resolution memory 108, and is input data to lookup table converter 109. The vertical axis is output data from lookup table converter 109. In other words, this output data does not generate an afterimage for each moving image resolution. Alternatively, this output data is the scrolling speed identifier that suppresses afterimages to a predetermined level or below. In this exemplary embodiment, this scrolling speed identifier is called the scrolling speed conversion identifier to distinguish from the scrolling speed identifier included in input subtitle data 124.

To calculate the value of this scrolling speed conversion identifier, the value of the scrolling speed identifier is changed relative to different moving image resolutions, and an afterimage in display unit 104 is measured. The value of the scrolling speed identifier that does not generate afterimages or suppresses afterimages to a predetermined value or below is measured in advance for each moving image resolution. In this way, a lookup table, which is the input and output conversion characteristics of lookup table converter 109, is prepared. This table is shown in FIG. 3.

As shown in FIG. 3, when the moving image resolution of display unit 104 is, for example, 800 to 900 lines, no afterimage is generated or afterimages are suppressed to a predetermined level or below in each moving image resolution by setting the scrolling speed identifier to 8 or below. To prevent generation of afterimages or to suppress afterimages is to a predetermined level or below when the moving image resolution of display unit 104 is 300 to 400 lines, FIG. 3 shows that the scrolling speed identifier is required to be 3 or below. In other words, the value of the scrolling speed identifier can be set greater as the moving image resolution of display unit 104 is higher. Accordingly, the scrolling speed can be made faster in higher moving image resolution.

In this way, lookup table converter 109 outputs the scrolling speed conversion identifier, which is a scrolling speed identifier that does not generate afterimages or suppresses afterimages to a predetermined level or below in each moving image resolution, to subtitle scroll converter 106 depending on the moving image resolution of display unit 104.

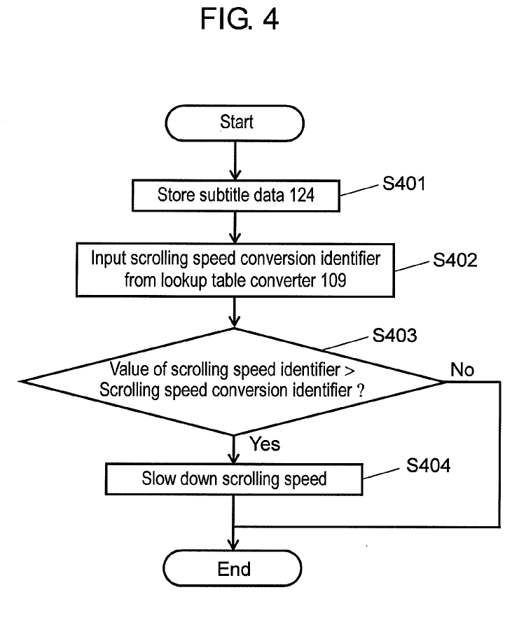

FIG. 4 is a flow chart of an example of the operation of digital television signal processor 21 in the first exemplary embodiment of the present invention. The operation of subtitle scroll converter 106 is detailed below.

First, subtitle data memory 105 receives and stores subtitle data 124. Then, stored subtitle data 124 is output to subtitle scroll converter 106 (Step S401).

Lookup table converter 109 outputs the scrolling speed conversion identifier, which does not generate afterimages or suppresses afterimages to a predetermined level or below, depending on the moving image resolution of display unit 104 stored in moving image resolution memory 108. Then, subtitle scroll converter 106 receives the scrolling speed conversion identifier output from lookup table converter 109 (Step S402).

Next, subtitle scroll converter 106 determines the scrolling speed. In other words, subtitle scroll converter 106 determines whether or not the value of scrolling speed identifier stored in subtitle data memory 105 exceeds the value of scrolling speed conversion identifier output from lookup table converter 109 (Step S403). If the determination is No, the operation is completed. If the determination is Yes, Step S404 described next is executed.

In Step S404, subtitle scroll converter 106 converts the value of scrolling speed identifier stored in subtitle data memory 105 to the value of scrolling speed conversion identifier input from lookup table converter 109. In this case, the subtitle scrolling speed is converted to a slower speed. Accordingly, the subtitle scrolling speed may become slower depending on the moving image resolution of display unit 104.

As described above, in digital television signal processor 21 in this exemplary embodiment, moving image resolution memory 108 stores the moving image resolution of display unit 104 in advance. Lookup table converter 109 then receives the moving image resolution stored in moving image resolution memory 108. Lookup table converter 109 outputs the scrolling speed conversion identifier based on the lookup table shown in FIG. 3.

Next, subtitle scroll converter 106 converts the value of scrolling speed identifier stored in subtitle data memory 105 to the value of scrolling speed conversion identifier output from lookup table converter 109 if the value of scrolling speed identifier of subtitle data 124 stored in subtitle data memory 105 exceeds the value of scrolling speed conversion identifier output from lookup table converter 109. In other words, subtitle scroll converter 106 in digital television signal processor 21 in this exemplary embodiment controls the subtitle scrolling speed depending on the moving image resolution of display unit 104.

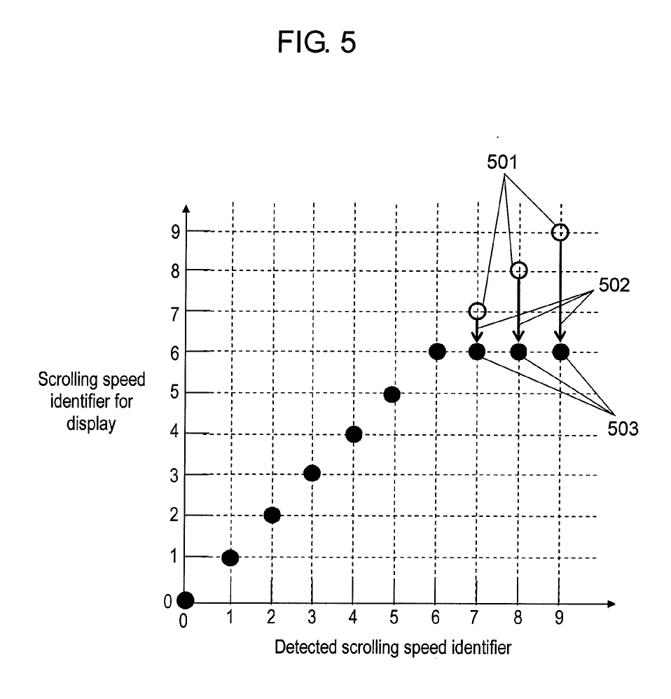

An example of further detailed operation of digital television signal processor 21 in this exemplary embodiment is described below. FIG. 5 illustrates the relationship between the scrolling speed identifier for display, corresponding to a predetermined scrolling speed conversion identifier, and detected scrolling speed identifier in digital television signal processor 21 in this exemplary embodiment. In FIG. 5, the horizontal axis indicates values of scrolling speed identifiers detected in subtitle data 124 input to digital television signal processor 21. The vertical axis indicates values of scrolling speed identifiers for display used for displaying on display unit 104.

As shown in FIG. 5, subtitle scroll converter 106 operates such that the maximum value “6” for the scrolling speed identifier for display becomes an upper limit for displaying on display unit 104. In this example, the value of scrolling speed conversion identifier output from lookup table converter 109 is assumed to be “6” as a predetermined value. In other words, if the scrolling speed identifier is 6 or below, it is assumed that no afterimage is generated or afterimage is generated only at a predetermined level or below on display unit 104.

In digital television signal processor 21, the scrolling speed identifier detected in input subtitle data 124 has possibilities of taking values from 0 to 9. However, if the detected scrolling speed identifier is from 7 to 9, as shown by white circles 501 in FIG. 5, these values are not preferably input to subtitle OSD generator 107 as they are as the scrolling speed identifier for display. This is because afterimages of a predetermined level or above may be generated on display unit 104.

Based on conversion characteristics shown in FIG. 5, subtitle scroll converter 106 converts the scrolling speed identifier based on the scrolling speed conversion identifier. More specifically, detected scrolling speed identifiers indicated by white circles 501 in FIG. 5 are converted to scrolling speed identifiers for display indicated by black circles 503 as shown by arrows 502, respectively. Using this scrolling speed identifier for display, subtitle OSD image signal 128 is generated as described below. If the detected scrolling speed identifier is from 0 to 6, there is no possibility of generating afterimages at a predetermined level or higher on display unit 104. Accordingly, the detected scrolling speed identifier is used as the scrolling speed identifier for display without any change.

More specifically, subtitle scroll converter 106 converts the value of scrolling speed identifier to the value of scrolling speed conversion identifier output from lookup table converter 109 if the value of scrolling speed identifier of subtitle data 124 stored in subtitle data memory 105 exceeds the value of scrolling speed conversion identifier output from lookup table converter 109.

Subtitle OSD generator 107 generates subtitle OSD image signal 128 based on this converted scrolling speed identifier. Subtitle OSD generator 107 then outputs this subtitle OSD image signal 128 to subtitle OSD synthesizer 103.

Next, subtitle OSD synthesizer 103 synthesizes input image signal 122 and subtitle OSD image signal 128 output from subtitle OSD generator 107. Subtitle OSD synthesizer 103 then outputs this synthesized display image signal 130 to display unit 104.

As described above, subtitle scroll converter 106 in digital television signal processor 21 in this exemplary embodiment controls the subtitle scrolling speed depending on the moving image resolution of display unit 104. More specifically, digital television signal processor 21 stores the moving image resolution of display unit 104 in advance, and controls and restricts the subtitle scrolling speed to a predetermined speed or below depending on this moving image resolution. Accordingly, afterimages are eliminated or suppressed to a predetermined level or below on display unit 104.

In addition to the moving image resolution of display unit 104, moving image resolution memory 108 may store a contrast ratio or the effective number of pixels of display unit 104, such as 1920×1080 pixels and 1028×768 pixels, so as to convert the scrolling speed depending on the contrast ratio or the effective number of pixels of display unit 104. More specifically, if the contrast ratio of display unit 104 is low, the subtitle is difficult to be identified. The scrolling speed is thus preferably made slower. If the number of effective pixels of display unit 104 is small, the subtitle is also difficult to be identified. The scrolling speed is thus preferably made slower. Accordingly, the subtitle suitable for user's viewing and hearing can be displayed by adopting the above way.

In this exemplary embodiment, a predetermined value of scrolling speed conversion identifier is assumed to be “6” in the description. However, the present invention is not limited to this predetermined value of “6.” Any value from “0” to “9” can be set. In addition, the predetermined value may be changed to any of the above values by user setting.

For changing the set predetermined value of scrolling speed conversion identifier, for example, remote control 110 may be used for the operation. A remote control input part for receiving the operation by remote control 110 is omitted in digital television signal processor 21 in this exemplary embodiment shown in FIG. 1. However, the remote control input part may be provided in subtitle scroll converter 106. Alternatively, the user may directly operate a button or knob (not illustrated in FIG. 1) provided in the input part of remote control, so as to change the predetermined value of scrolling speed conversion identifier in subtitle scroll converter 106. This enables the user to set the subtitle scrolling speed most suitable for himself/herself.

### Second Exemplary Embodiment

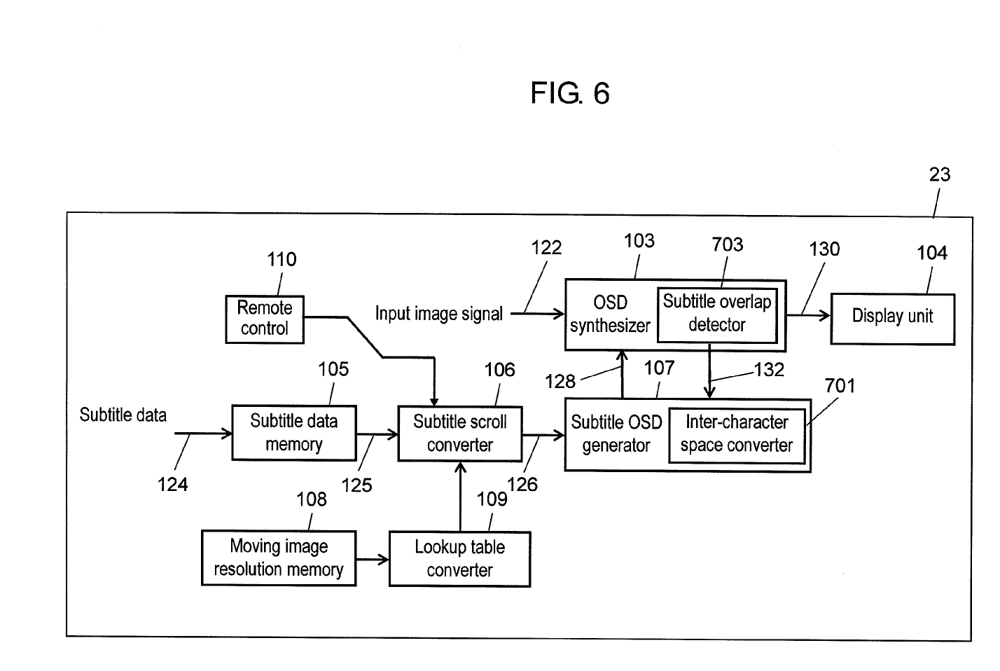

FIG. 6 is a diagram of digital television signal processor 23 in the second exemplary embodiment of the present invention. Digital television signal processor 21 in the first exemplary embodiment of the present invention stores moving image resolution of display unit 104, and restricts the subtitle scrolling speed to a predetermined level or below depending on that moving image resolution. Digital television signal processor 23 in the second exemplary embodiment of the present invention differs from the first exemplary embodiment with respect to a point that inter-character space of subtitle is narrowed in subtitle data 126 after converting the scrolling speed.

More specifically, as shown in FIG. 6, in digital television signal processor 23 in this exemplary embodiment, subtitle OSD synthesizer 103 further includes subtitle overlap detector 703 for detecting any overlap between subtitle and another content included in input image signal 122 in the structure of digital television signal processor 21 in the first exemplary embodiment shown in FIG. 1. In addition, subtitle OSD generator 107 further includes inter-character space converter 701.

Subtitle OSD synthesizer 103 receives input image signal 122 and subtitle OSD image signal 128 output from subtitle OSD generator 107, synthesizes display image signal 130, and outputs it to display unit 104. Subtitle overlap detector 703 detects any overlap between subtitle and another content included in input image signal 122. As a result, if an overlap is detected, subtitle overlap detection signal 132 that indicates detection of overlap between the subtitle and another content included in input image signal 122 is output to subtitle OSD generator 107. Another content means another content after the content where a target subtitle is superimposed. For example, another content is a commercial message (hereafter referred to as “CM”) that is not related to the target subtitle. Or, another content is a content of another scene that is not related to the target subtitle after the scene where the target subtitle is superimposed.

If subtitle OSD generator 107 receives subtitle overlap detection signal 132, inter-character space converter 701 in subtitle OSD generator 107 converts subtitle data 126 and narrows the inter-character space of subtitle. Detailed description of the structure and operation equivalent to that of the first exemplary embodiment is omitted.

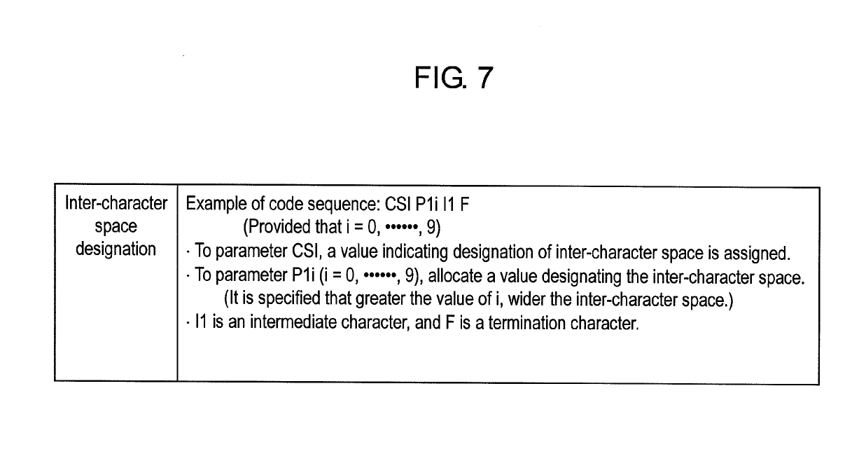

Now, the inter-character space of subtitle is described. Subtitle data 124 includes a parameter for designating inter-character space of subtitle. FIG. 7 is an example of data formation of extended control signal including a subtitle inter-character space parameter. In other words, FIG. 7 shows an example of specification of the inter-character space parameter for designating the subtitle inter-character space. A code sequence that designates the subtitle inter-character space is, for example, “CSI P1i (i=0, . . . , 9) I1 F.” Here, a value indicating that this code is for designating the inter-character space is assigned to parameter CSI. Parameter P1i (i=0, . . . , 9) designates the inter-character space in subtitle. This parameter specifies that the inter-character space becomes wider as the value of i becomes greater. Parameter I1 is an intermediate character in the code sequence of subtitle, and parameter F is a termination character that delimits the code sequence.

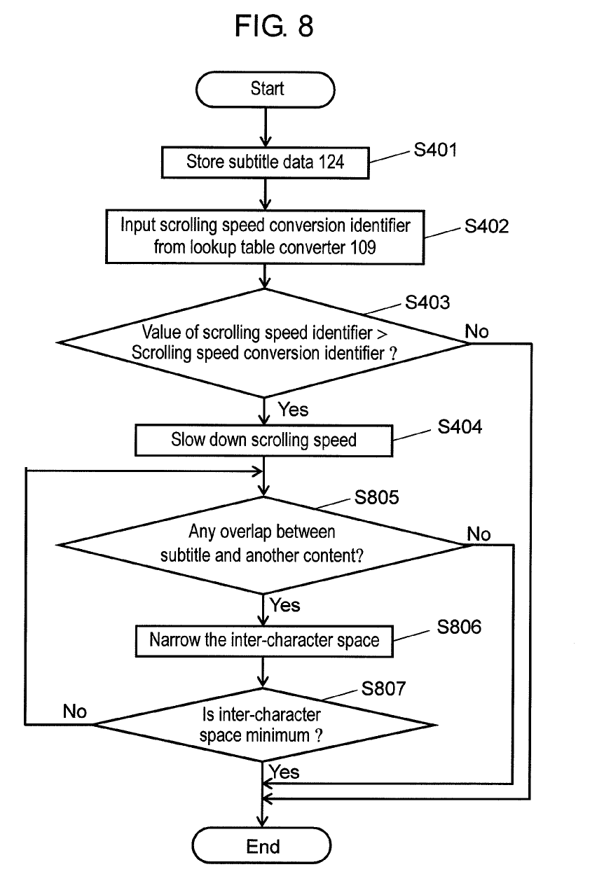

Next is described the operation of subtitle OSD generator 107 including inter-character space converter 701 in digital television signal processor 23 in this exemplary embodiment. FIG. 8 is a flow chart illustrating an example of the operation of digital television signal processor 23 in the second exemplary embodiment of the present invention. The flow chart in FIG. 8 includes processes of Step S805, Step S806, and Step S807, which are described later, in addition to Step S401 to Step S404 in the flow chart indicated as an example of the operation of digital television signal processor 21 in the first exemplary embodiment of the present invention described with reference to FIG. 4. Accordingly, the operations from Step S401 to Step S404 are the same as that in the first exemplary embodiment, and thus their description is omitted here.

In Step S404, as shown in FIG. 8, subtitle scroll converter 106 converts a value of the scrolling speed identifier stored in subtitle data memory 105 to a value of the scrolling speed conversion identifier input from lookup table converter 109. In this case, the subtitle scrolling speed is slowed down. Accordingly, the subtitle scrolling speed may be converted to a slower speed depending on the moving image resolution of display unit 104.

Then, subtitle overlap detector 703 detects any overlap between the subtitle and another content included in input image signal 122 (Step S805). As a result, if any overlap is detected (Yes), subtitle overlap detection signal 132 that indicates detection of overlap between the subtitle and another content included in input image signal 122 is output to subtitle OSD generator 107.

If subtitle OSD generator 107 receives subtitle overlap detection signal 132, inter-character space converter 701 converts subtitle data 126 to narrow the inter-character space (Step S806). Next, whether or not the inter-character space is minimum is determined (Step S807). If the inter-character space is minimum, the operation is completed. If no overlap between the subtitle and another content included in input image signal 122 is detected (No), the operation is also completed.

In this way, subtitle OSD generator 107 in digital television signal processor 23 in this exemplary embodiment reduces a value of the inter-character space identifier if subtitle overlap detector 703 detects any overlap between subtitle and another content included in input image signal 122. Digital television signal processor 23 repeats a series of these operations until subtitle overlap detector 703 does not detect any overlap between subtitle and another content included in input image signal 122.

As described above, also in the second exemplary embodiment, a display time of subtitle becomes longer if the scrolling speed is made slower, same as that described in the first exemplary embodiment. However, in this exemplary embodiment, the subtitle inter-character space can also be made smaller in subtitle data 126 after converting the scrolling speed. Accordingly, the subtitle scrolling time can be made shorter.

For example, if the subtitle scrolling time is doubled by slowing down the scrolling speed, the subtitle scrolling time may be shortened to half or less by narrowing the inter-character space. As a result, the subtitle scrolling time can be shortened until the subtitle does not overlap with another content, such as CM.

In other words, digital television signal processor 23 in this exemplary embodiment narrows the inter-character space so as to shorten the subtitle scrolling time until the subtitle is not superimposed on another content, if an overlap between the subtitle and another content included in input image signal 122 is detected due to extended subtitle scrolling time after converting the scrolling speed. Accordingly, the inter-character space is not necessarily narrowed to the minimum space. In other words, subtitle OSD generator 107 operates to narrow down the subtitle inter-character space as needed to prevent an overlap between subtitle and another content, in order to avoid degradation in readability of subtitle. Accordingly, afterimages are eliminated or suppressed to a predetermined level or below on display unit 104 by slowing down the subtitle scrolling speed. In addition, the subtitle can be displayed without being superimposed on another content.

In this exemplary embodiment, the inter-character space is narrowed to shorten the subtitle scrolling time. However, the number of lines may be changed from a single line to two or more lines, or a font size of subtitle may be reduced.

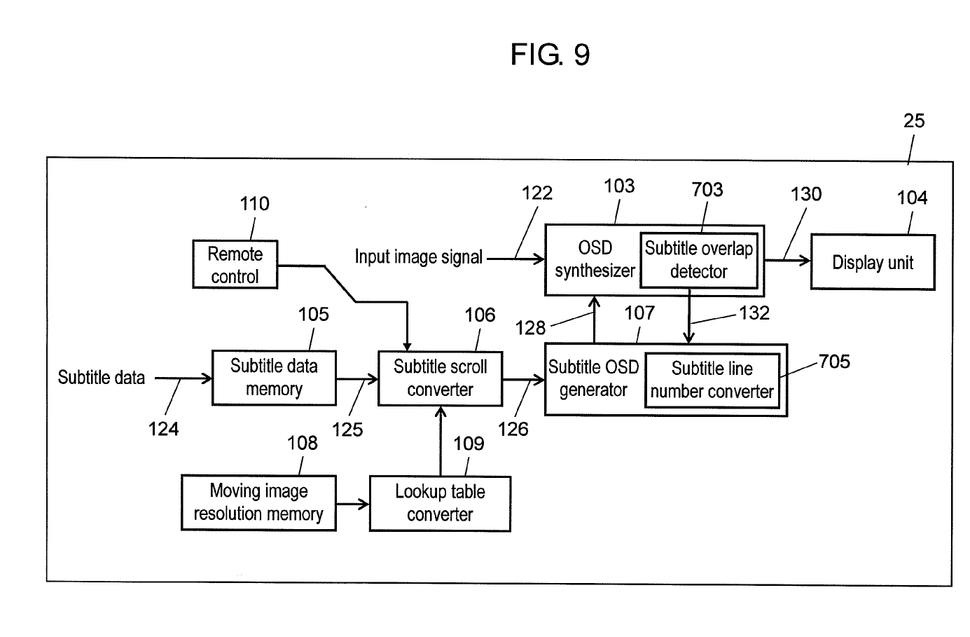

FIG. 9 is a diagram of another example of digital television signal processor 25 in the second exemplary embodiment of the present invention. This example of digital television signal processor 25 includes subtitle line number converter 705 for converting the number of subtitle lines from a single line to two lines, as shown in FIG. 9, instead of inter-character space converter 701 in the structure of digital television signal processor 23 in the exemplary embodiment shown in FIG. 6. In other words, subtitle line number converter 705 has a function to convert subtitle data 126 to change the number of lines of subtitle from one to two or more lines for display.

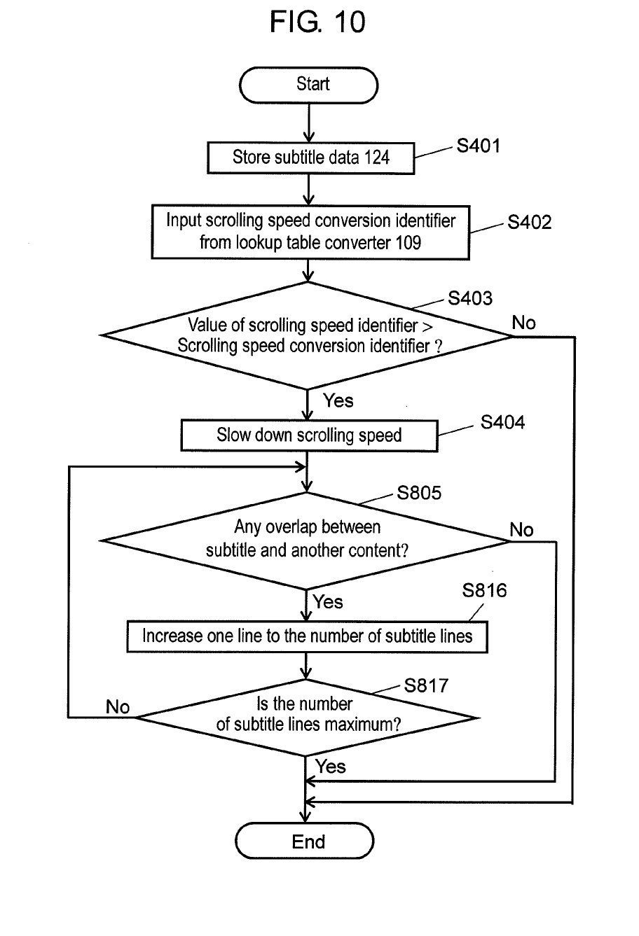

Next, the operation of subtitle line number converter 705 is detailed below. FIG. 10 is a flow chart of an example of the operation of another example of digital television signal processor 25 in the second exemplary embodiment of the present invention. The operation up to Step S805 is the same as that of digital television signal processor 23 in this exemplary embodiment, and thus their description is omitted here.

In Step S805, subtitle line number converter 705 converts subtitle data 126 to change the display of subtitle from one line to two lines if subtitle OSD generator 107 receives subtitle overlap detection signal 132 (Yes). More specifically, the number of lines of subtitle is increased for one line (Step S816). Then, whether or not the number of subtitle lines is a predetermined value and maximum is determined. If the number of subtitle lines can be further increased, i.e., the number of subtitle lines is smaller than the predetermined value (No), the operation returns to Step S805. Otherwise (Yes), the operation is completed.

In this way, subtitle OSD generator 107 in another example of digital television signal processor 25 in this exemplary embodiment increases one subtitle line if subtitle overlap detector 703 detects any overlap between the subtitle and another content included in input image signal 122 after converting the subtitle scrolling speed. In other words, subtitle line number converter 705 converts the number of subtitle lines to display the subtitle in two ore more lines. Digital television signal processor 23 repeats this series of operation until subtitle overlap detector 703 detects no overlap between the subtitle and another content included in input image signal 122.

For example, if the subtitle scrolling time has been extended up to twice as much by slowing down the scrolling speed, subtitle data 126 may be converted to display the subtitle in two lines instead of one line. In this way, the number of subtitle display lines is increased to shorten the subtitle scrolling time to the extent more than the extended subtitle scrolling time after converting the scrolling speed. The maximum number of lines as a predetermined value when the number of subtitle lines is increased depends on the number of effective pixels of display unit 104. For example, the maximum number of lines may be set to four lines. This is because; it is inconceivable that the subtitle scrolling time after converting the scrolling speed is extended more than fourfold. This enables shortening of the subtitle scrolling time until the subtitle is not superimposed on another content, such as CM. Accordingly, afterimages are eliminated or suppressed to a predetermined level or below on display unit 104 by slowing down the subtitle scrolling speed. In addition, the subtitle is not superimposed on another content at displaying the subtitle.

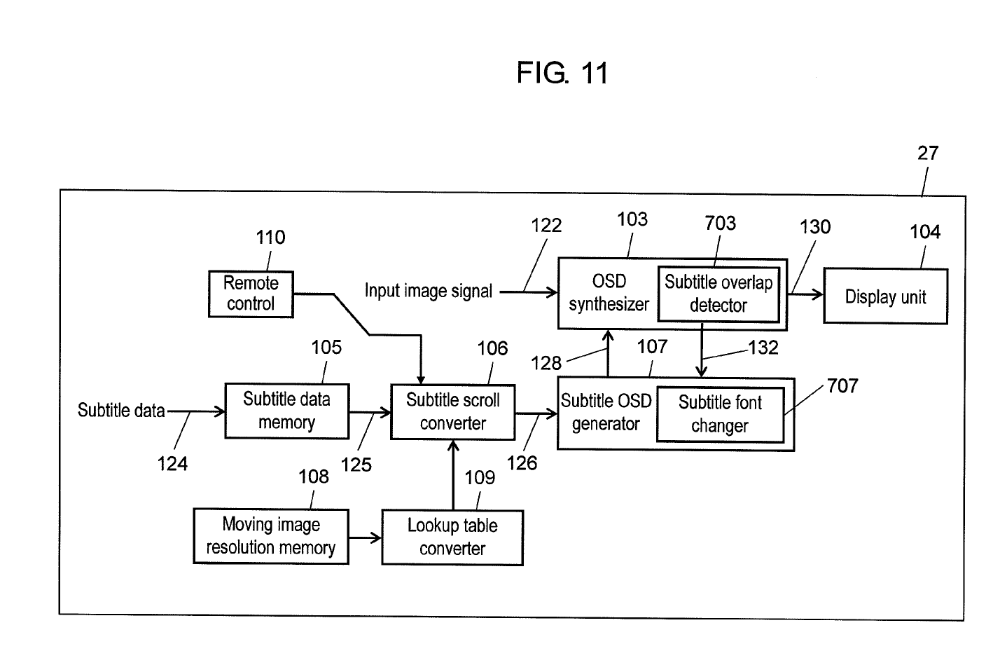

FIG. 11 is a diagram of further another example of digital television signal processor 27 in the second exemplary embodiment of the present invention. In this example, digital television signal processor 27 includes subtitle font changer 707 for changing the font size of subtitle smaller, instead of inter-character space converter 701 in digital television signal processor 23 in this exemplary embodiment of the present invention shown in FIG. 6. In other words, subtitle font changer 707 has a function to reduce the font size of subtitle.

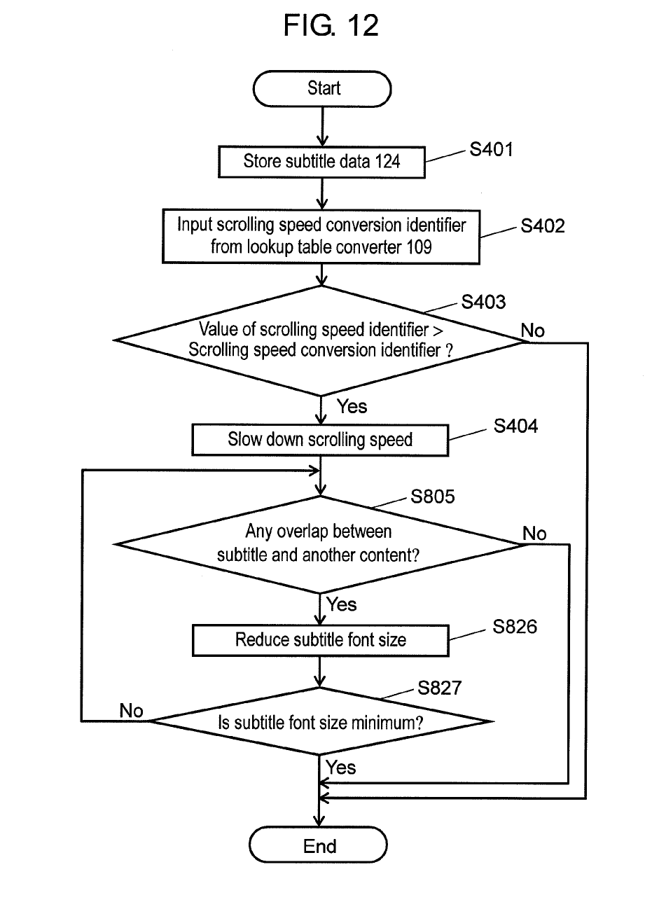

Next, the operation of subtitle font changer 707 is detailed below. FIG. 12 is a flow chart of an example of the operation of further another example of digital television signal processor 27 in the second exemplary embodiment of the present invention. The operation up to Step S805 is the same as that in digital television signal processor 23 in the exemplary embodiment of the present invention, and thus its description is omitted here. If subtitle OSD generator 107 inputs subtitle overlap detection signal 132 (Yes) in Step S805, subtitle font changer 707 reduces the font size of subtitle in subtitle data 126 (Step S826). A reduced font size depends on font sizes provided in subtitle OSD generator 107. For example, the font size may be reduced step-by-step with respect to font sizes provided in subtitle OSD generator 107.

Next, whether or not the font size of subtitle is a predetermined minimum size is determined (Step S827). If the font size of subtitle can be further reduced, i.e., the font size of subtitle is larger than the predetermined minimum size (No), the operation returns to Step S805. Otherwise (Yes), the operation is completed.

In this way, subtitle OSD generator 107 in further another example of digital television signal processor 25 in this exemplary embodiment changes the font size of subtitle to a smaller font size if subtitle overlap detector 703 detects any overlap between the subtitle and another content included in input image signal 122 after converting the subtitle scrolling speed. Digital television signal processor 23 repeats this series of operation until subtitle overlap detector 703 does not detect any overlap between subtitle and another content included in input image signal 122. A predetermined minimum font size of subtitle depends on the number of effective pixels of display unit 104. For example, the minimum size may be 16×16 dots. This enables shortening of the subtitle scrolling time until the subtitle is not superimposed on another content, such as CM. Accordingly, afterimages are eliminated or suppressed to a predetermined level or below on display unit 104 by slowing down the subtitle scrolling speed. In addition, the subtitle can be displayed without being superimposed on another content.

### Third Exemplary Embodiment

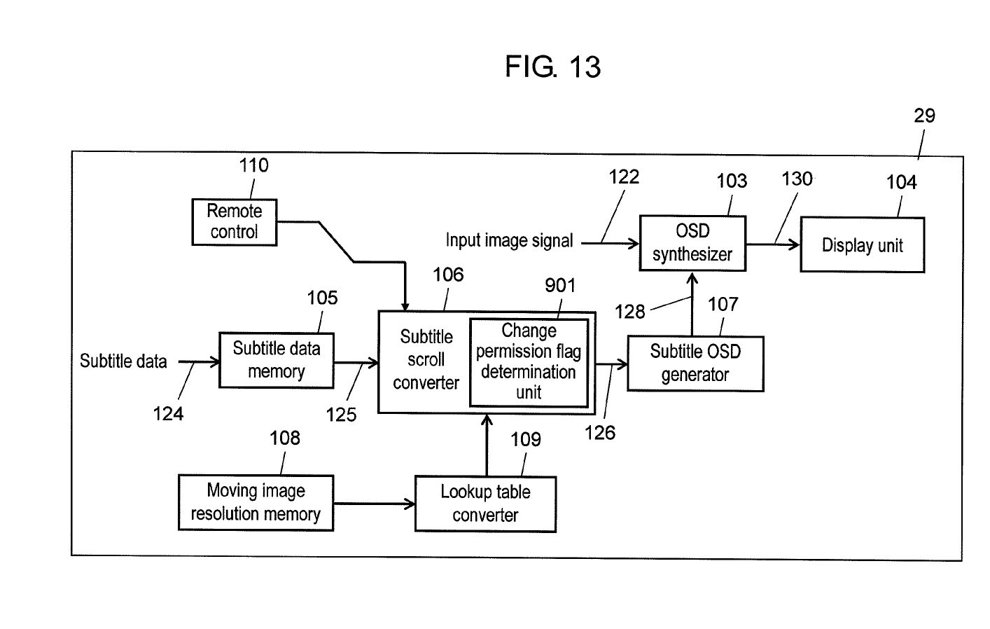

FIG. 13 is a diagram of digital television signal processor 29 in the third exemplary embodiment of the present invention. In digital television signal processor 21 in the first exemplary embodiment of the present invention, moving image resolution of display unit 104 is stored, and the subtitle scrolling speed is restricted to a predetermined value or below depending on the moving image resolution. Digital television signal processor 29 in the third exemplary embodiment of the present invention differs with respect to a point that whether or not to change the subtitle scrolling speed is determined using a permission flag.

More specifically, as shown in FIG. 13, in digital television signal processor 29 in this exemplary embodiment, subtitle scroll converter 106 further includes change permission flag determination unit 901 for determining whether or not to change the subtitle scrolling speed in the structure of digital television signal processor 21 in the first exemplary embodiment shown in FIG. 1.

Subtitle scroll converter 106 makes reference to the change permission flag for scrolling speed included in input subtitle data 125. Subtitle scroll converter 106 then determines whether or not this change permission flag permits change. Based on this determination result, whether or not to change the scrolling speed identifier is determined. Same reference marks are given to the structure same as that described in the first exemplary embodiment, their description is omitted here.

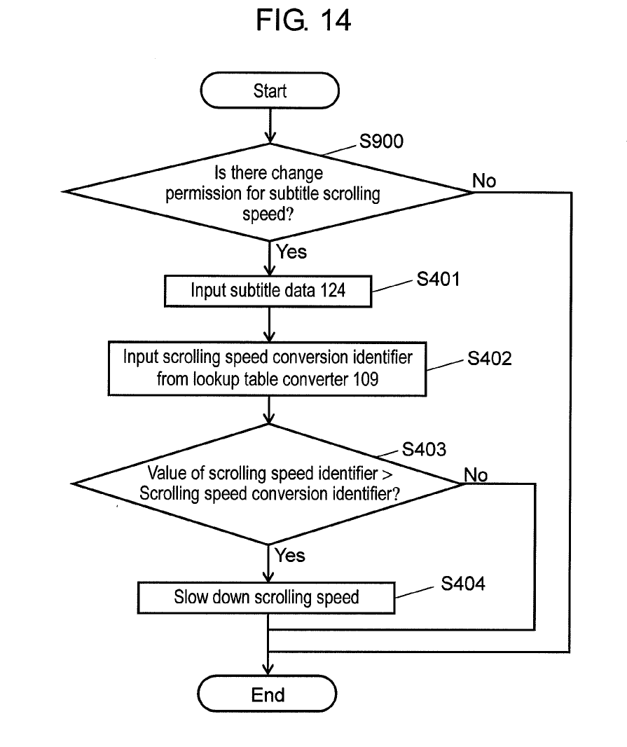

FIG. 14 is a flow chart of an example of the operation of digital television signal processor 29 in the third exemplary embodiment of the present invention. In the flow chart in FIG. 14, Step S900, which is described later, is added to steps S401 to S404 in the flow chart of an example of the operation of digital television signal processor 21 in the first exemplary embodiment described with reference to FIG. 4.

In FIG. 14, subtitle scroll converter 106 makes reference to the change permission flag for subtitle scrolling speed included in input image data 125. Whether or not this change permission flag permits change is determined (Step S900). If the change is permitted (Yes), the operation proceeds to Step S401. Then, the operation of subtitle scrolling speed conversion equivalent to the operation flow described in the first exemplary embodiment is executed. Its description is thus omitted here. If the change is not permitted (No) in Step S900, the operation is completed.

In this exemplary embodiment, the change permission flag for subtitle scrolling speed needs to be included in an extended identifier of subtitle data 125.

As described above, in digital television signal processor 29 in this exemplary embodiment, subtitle scroll converter 106 makes reference to the change permission flag for scrolling speed included in subtitle data 125. Subtitle scroll converter 106 also includes change permission flag determination unit 901 for determining whether or not to change the subtitle scrolling speed. Subtitle scroll converter 106 executes conversion depending on determination on change by change permission flag determination unit 901. If the change permission flag for subtitle scrolling speed permits change, the scrolling speed identifier is converted. If the change permission flag for scrolling speed does not permit change, conversion of scrolling speed identifier is stopped.

With this structure, the present invention offers digital television signal processor 29 that uses the permission flag for determining whether or not to change the subtitle scrolling speed. Accordingly, a content designer can select whether or not to change the subtitle scrolling speed, and thus the subtitle can be displayed at content designer's intended scrolling speed.

### INDUSTRIAL APPLICABILITY

The digital television signal processor of the present invention enables elimination of afterimages or suppression of afterimages to a predetermined level or below at scrolling subtitles. Accordingly, the present invention is extremely effective when applied to display devices with low moving image resolution, such as LCDs.

1-14. (canceled)

15. An image display processor that receives an input image signal and a digital signal including subtitle data, and displays the input image signal and the digital signal on a display unit, the image display processor comprising:
a subtitle scroll converter for determining a subtitle scrolling speed depending on a display capability of the display unit;
a subtitle data memory for storing the subtitle data;
a subtitle OSD (On Screen Display) generator for outputting a subtitle OSD image signal from the subtitle data depending on the subtitle scrolling speed determined by the subtitle scroll converter; and
a subtitle OSD synthesizer for synthesizing a display image signal upon receiving the input image signal and the subtitle OSD image signal.

16. The image display processor of claim 15, wherein the display capability of the display unit is at least one of moving image resolution, a contrast ratio, and the number of effective pixels of the display unit.

17. An image display processor that receives an input image signal and a digital signal including subtitle data, and displays the input image signal and the digital signal on a display unit, the digital television signal processor comprising:
a moving image resolution memory for storing a display capability of the display unit;
a lookup table converter for outputting a subtitle scrolling speed conversion identifier depending on the display capability of the display unit;
a subtitle data memory for storing the subtitle data;
a subtitle scroll converter for converting a scrolling speed identifier based on the scrolling speed conversion identifier output from the lookup table converter, the scrolling speed identifier determining a subtitle scrolling speed, the scrolling speed identifier being included in the subtitle data stored in the subtitle data memory;
a subtitle OSD (On Screen Display) generator for outputting a subtitle OSD image signal from the subtitle data based on the converted scrolling speed identifier output from the subtitle scroll converter; and
a subtitle OSD synthesizer for synthesizing a display image signal upon receiving the input image signal and the subtitle OSD image signal,
wherein the subtitle scroll converter controls the subtitle scrolling speed depending on the display capability of the display unit.

18. The image display processor of claim 17, wherein the display capability of the display unit is moving image resolution.

19. The image display processor of claim 17, wherein the display capability of the display unit is the number of effective pixels.

20. The image display processor of claim 17, wherein the subtitle scroll converter controls the subtitle scrolling speed such that the subtitle scrolling speed is not greater than a predetermined value depending on the display capability of the display unit.

21. The image display processor of claim 17, wherein the subtitle scroll converter converts a value of the scrolling speed identifier stored in the subtitle data memory to a value of the scrolling speed conversion identifier output from the lookup table converter if the value of the scrolling speed identifier in the subtitle data stored in the subtitle data memory exceeds the value of the scrolling speed conversion identifier output from the lookup table converter.

22. The image display processor of claim 17,
wherein the subtitle OSD synthesizer further includes a subtitle overlap detector for detecting an overlap between the subtitle and another content included in the input image signal,
wherein the subtitle OSD generator further includes an inter-character space converter for converting an inter-character space of the subtitle, and
wherein the inter-character space converter narrows the inter-character space of the subtitle if the subtitle overlap detector detects an overlap between the subtitle and another content included in the input image signal.

23. The image display processor of claim 17,
wherein the subtitle OSD synthesizer further includes a subtitle overlap detector for detecting an overlap between the subtitle and another content included in the input image signal,
wherein the subtitle OSD generator further includes a subtitle line number converter for converting the number of lines of the subtitle, and
wherein the subtitle line number converter converts the number of lines of the subtitle to not less than two lines for display if the subtitle overlap detector detects an overlap between the subtitle and another content included in the input image signal.

24. The image display processor of claim 17,
wherein the subtitle OSD synthesizer further includes a subtitle overlap detector for detecting an overlap between the subtitle and another content included in the input image signal,
wherein the subtitle OSD generator further includes a subtitle font changer for changing a font size of the subtitle, and
wherein the subtitle font changer reduces the font size of the subtitle if the subtitle overlap detector detects an overlap between the subtitle and another content included in the input image signal.

25. The image display processor of claim 17,
wherein the subtitle scroll converter further includes a change permission flag determination unit for determining whether or not to change the subtitle scrolling speed by making reference to a change permission flag for the scrolling speed, the change permission flag being included in the subtitle data, and
wherein the subtitle scroll converter:
converts the scrolling speed identifier if the change permission flag permits change of the scrolling speed; and
does not convert the scrolling speed identifier if the change permission flag does not permit change of the scrolling speed.

26. A method of displaying a subtitle in an image display processor that receives an input image signal and a digital signal including subtitle data, and displays the input image signal and digital signal on a display unit, the method comprising:
storing moving image resolution or the number of effective pixels of the display unit;
outputting a subtitle scrolling speed conversion identifier depending on the moving image resolution or the number of effective pixels;
storing the subtitle data;
converting a scrolling speed identifier based on the scrolling speed conversion identifier, the scrolling speed identifier determining a subtitle scrolling speed, the scrolling speed identifier being included in the stored subtitle data;
outputting a subtitle OSD (On Screen Display) image signal from the subtitle data based on the converted scrolling speed identifier;
synthesizing a display image signal upon receiving the input image signal and the subtitle OSD image signal; and
controlling the subtitle scrolling speed depending on the moving image resolution or the number of effective pixels of the display unit.

27. The method of displaying a subtitle of claim 26,
wherein the subtitle is displayed by controlling the subtitle scrolling speed such that the subtitle scrolling speed is not greater than a predetermined value depending on the moving image resolution or the number of effective pixels of the display unit.

28. The method of displaying a subtitle of claim 26, wherein a value of the scrolling speed identifier is converted to a value of the scrolling speed conversion identifier if the value of the scrolling speed identifier in the stored subtitle data exceeds the value of the scrolling speed conversion identifier.

29. The method of displaying a subtitle of claim 26,
wherein a presence of overlap between the subtitle and another content included in the input image signal is detected, and
wherein an inter-character space of the subtitle is narrowed if an overlap between the subtitle and another content included in the input image signal is detected.

30. The method of displaying a subtitle of claim 26,
wherein a presence of overlap between the subtitle and another content included in the input image signal is detected, and
wherein a subtitle line number converter displays the subtitle in not less than two lines if an overlap between the subtitle and another content included in the input image signal is detected.

31. The method of displaying a subtitle of claim 26,
wherein a presence of overlap between the subtitle and another content included in the input image signal is detected, and
wherein a font size of the subtitle is reduced if an overlap between the subtitle and another content included in the input image signal is detected.

32. The method of displaying a subtitle of claim 26,
wherein whether or not to change the subtitle scrolling speed is determined by making reference to a change permission flag for scrolling speed included in the subtitle data, and
wherein conversion of the scrolling speed identifier is:
executed if the change permission flag for the scrolling speed permits change of the scrolling speed; and
not executed if the change permission flag for the scrolling speed does not permit change of the scrolling speed.

33. A method of displaying a subtitle in an image display processor that receives an input image signal and a digital signal including subtitle data, and displays the input image signal and digital signal on a display unit, the method comprising:
determining a subtitle scrolling speed depending on a display capability of the display unit;
storing the subtitle data;
outputting a subtitle OSD (On Screen Display) image signal from the subtitle data depending on the determined subtitle scrolling speed; and
synthesizing a display image signal upon receiving the input image signal and the subtitle OSD image signal.
